(19) United States
(12) Patent Application Publication
(10) Pub. No.: US 2016/0223777 A1
(43) Pub. Date: Aug. 4, 2016

(54) ACTUATOR AND CAMERA MODULE

(71) Applicant: SAMSUNG ELECTRO-MECHANICS CO., LTD., Suwon-si (KR)

(72) Inventors: Kyeong Jun KIM, Suwon-si (KR); Yoo Chang KIM, Suwon-si (KR); Jung Seok LEE, Suwon-si (KR); Sung Hoon KIM, Suwon-si (KR); Man Su KIM, Suwon-si (KR); Jae Ho BAIK, Suwon-si (KR); Po Chul KIM, Suwon-si (KR); Myung Ki LEE, Suwon-si (KR)

(73) Assignee: SAMSUNG ELECTRO-MECHANICS CO., LTD., Suwon-si (KR)

(21) Appl. No.: 14/969,710

(22) Filed: Dec. 15, 2015

(30) Foreign Application Priority Data
Feb. 2, 2015 (KR) 10-2015-0016223

(51) Int. Cl. G02B 7/08; H02K 41/035; H02K 11/22; H02K 11/33; H02K 11/215

(52) U.S. Cl. CPC G02B 7/08; H02K 11/33; H02K 11/215; H02K 11/022; H02K 41/0356

(57) ABSTRACT

An actuator including a printed circuit board comprising an external connection pad formed on one surface of the printed circuit board; a magnet disposed to face another surface of the printed circuit board; a coil portion disposed on the one surface of the printed circuit board; and a driver integrated circuit (IC), installed on the one surface of the printed circuit board, configured to control a current applied to the coil portion.

### CROSS-REFERENCE TO RELATED APPLICATION

This application claims the benefit under 35 USC 119(a) of Korean Patent Application No. 10-2015-0016223 filed on Feb. 2, 2015, in the Korean Intellectual Property Office, the disclosure of which is incorporated herein by reference for all purposes.

### BACKGROUND

1. Field

The following description relates to an actuator and a camera module.

2. Description of Related Art

In general, a digital camera captures images using an image sensor such as a charge coupled device (CCD) or a complementary metal-oxide semiconductor (CMOS) instead of a film. A camera module for capturing images has been used in various devices such as in mobile devices having a camera function, tablet personal computers (PC), and monitors or surveillance cameras installed in vehicles, due to having a relatively small volume and excellent performance. In particular, camera modules used in mobile devices have been gradually multifunctionalized, miniaturized, and lightened, in accordance with current trends.

Camera modules recently used in mobile devices commonly have an auto focusing function and an optical image stabilization (OIS) function, and devices included in a camera module also need to meet miniaturization requirements by virtue of the miniaturization of lenses and increases in levels of optical performance. Various types of actuator are commonly used to drive camera modules, such as voice coil motors (VCM), step motors, piezoelectric actuators, micro electro mechanical systems (MEMS), and so on. A voice coil motor (VCM)-type actuator, commonly used as an actuator in a camera module, uses Lorentz force, that is, electromagnetic force generated between an electrical field and a magnetic field.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, an actuator and a camera module is provided in which a terminal portion or a driver integrated circuit mounted on a printed circuit board prevents damage to the printed circuit board while having a simplified structure. The structure of the printed circuit board is simplified through various connection pads, a coil portion, and a driver IC being disposed on one surface of the printed circuit board. In addition, a single sided printed circuit board may be used so as to reduce manufacturing costs.

In another general aspect, an actuator and a camera module prevents damage to a coil portion or a driver IC, which may occur as a lens barrel disposed to face the other surface of the printed circuit board is driven, by disposing various connection pads, a coil portion, and a driver IC on one surface of the printed circuit board.

In another general aspect, an actuator includes a printed circuit board having an external connection pad formed on one surface of the printed circuit board; a magnet disposed to face another surface of the printed circuit board; a coil portion disposed on the one surface of the printed circuit board; and a driver integrated circuit (IC), installed on the one surface of the printed circuit board, configured to control a current applied to the coil portion.

In another general aspect, a camera module includes a lens barrel; a lens disposed in the lens barrel; a housing, wherein the lens barrel is disposed in the housing; and an actuator configured to move the lens barrel along an optical axis of the lens. The actuator includes a printed circuit board, coupled to the housing, having an external connection pad formed on one surface of the printed circuit board, a magnet coupled to an outer circumferential surface of the lens barrel to face another surface of the printed circuit board, a coil portion installed on the one surface of the printed circuit board, and a driver integrated circuit (IC), disposed on the one surface of the printed circuit board, configured to control a current applied to the coil portion.

Other features and aspects will be apparent from the following detailed description, the drawings, and the claims.

### BRIEF DESCRIPTION OF DRAWINGS

FIG. 1 is a schematic diagram illustrating an actuator;

FIG. 2 is a plan view illustrating a printed circuit board used in an actuator;

FIG. 3 is a perspective view of a camera module; and

FIG. 4 is an exploded perspective view of a camera module.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

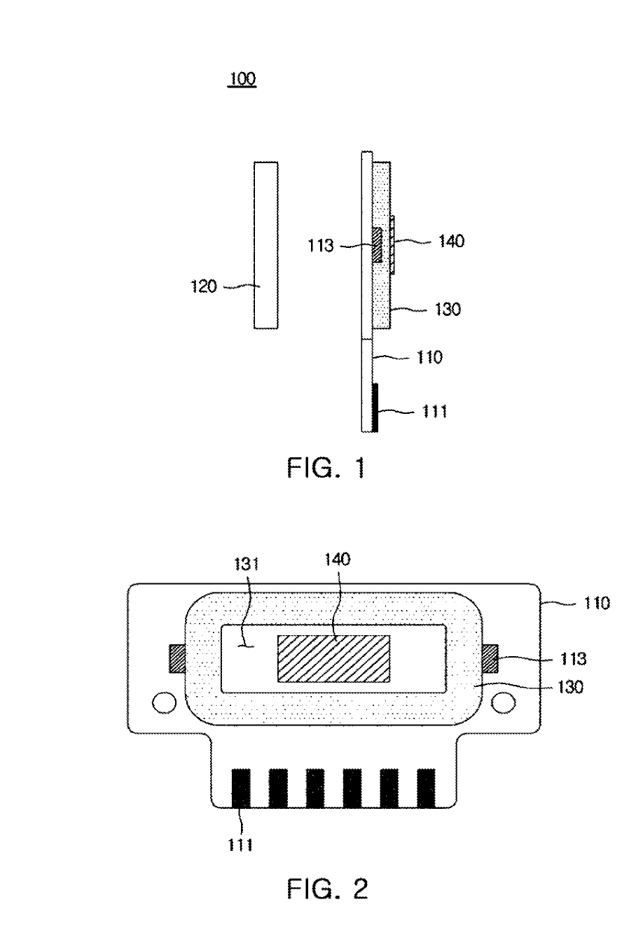

Referring to FIGS. 1 and 2, an actuator 100 includes a printed circuit board 110, a magnet 120, a coil portion 130, and a driver integrated circuit (IC) 140. The printed circuit board 110 includes an external connection pad 111 formed on one surface thereof. The external connection pad 111 is formed on one surface of the printed circuit board 110 and connects the printed circuit board 110 to an external power source, an image sensor, or other external component.

The external connection pad 111 may be formed via various methods of coating, plating, or deposition a conductive material. The external connection pad 111 protrudes from one surface of the printed circuit board 110 or may be formed in such manner that one surface of the external connection pad 111 is concave from one surface of the printed circuit board 110.

Although FIG. 2 shows six external connection pads 111, the number of external connection pads may vary according to design or process requirements. Similarly, a location of one surface of the printed circuit board 110, on which the external connection pad 111 is formed, is not limited to a lower end of the printed circuit board 110 shown in FIG. 2. The external connection pad 111 connects the printed circuit board 110 to an external power source and other external components.

The printed circuit board 110 may be a flexible printed circuit board or a rigid printed circuit board. In the case of the flexible printed circuit board, the actuator 100 is slim, while a rigid printed circuit board provides rigidity to support the coil portion 130 and the driver IC 140, and will be described later.

Formed on the surface of the printed circuit board 110 is a coil connection pad 113 electrically connected to the coil portion 130. The coil connection pad 113 may be formed via various methods of coating conductive paste, plating, or deposition. The coil connection pad 113 protrudes from one surface of the printed circuit board 110 or may be formed in such way that a portion of the coil connection pad 113 is concave, or formed as a groove in one surface of the printed circuit board 110. The position of the coil connection pad 113 may be changed in various manners, according to design or process requirements, as long as the coil connection pad 113 is electrically connected to the coil portion 130. The connection between the coil connection pad 113 and the coil portion 130 will be described later.

The magnet 120 is disposed to face the other surface of the printed circuit board 110. That is, the magnet 120 may face the coil portion 130 and the driver IC 140, to be described later, with the printed circuit board 110 disposed therebetween.

The magnet 120 generates a magnetic field to interact with the coil portion 130 to generate a Lorenz force, described below. Accordingly, in a situation in which the coil portion 130 is fixed, the magnet 120 may be displaced through the Lorenz force. Similarly, in a situation in which the magnet 120 is fixed, the coil portion 130 may be displaced through the Lorenz force.

The coil portion 130 is installed on one surface of the printed circuit board 110. The coil portion 130 may be formed by winding consecutive unit coils several times or may be formed by connecting a plurality of discontinuous unit coils to each other. When current is applied to the coil portion 130, an electrical field is generated and thus may generate a Lorentz force together with the magnet 120. A unit coil includes a conductive material. In addition, the unit coil includes a material with ductility so the shape of the coil portion 130 may be easily formed. Since the coil portion 130 is installed on one surface of the printed circuit board 110, and the magnet is disposed to face an opposite surface of the printed circuit board 110, the coil portion 130 does not directly face the magnet 120, thereby preventing problems such as damage due to contact between the coil portion 130 and the magnet 120.

The driver IC 140 is installed on one surface of the printed circuit board 110 so as to control current applied to the coil portion 130. That is, the driver IC 140 controls a current applied to the coil portion 130 so as to control the amplitude and direction of Lorentz force generated between the coil portion 130 and the magnet 120.

An opening 131 in the coil portion 130 is formed to include a gap between the coil portion 130 and the driver IC 140 in order to control a current applied to the coil portion 130. Since the driver IC 140 is installed on one surface of the printed circuit board 110, the driver IC 140 does not directly face the magnet 120, thereby preventing problems such as damage due to contact between the driver IC 140 and the magnet 120. Accordingly, in the actuator 100, the magnet 120 faces the coil portion 130 and the driver IC 140 across the printed circuit board 110, thereby preventing damage to the magnet 120, the coil portion 130, or the driver IC 140, which may occur as the magnet 120 or the printed circuit board 110 moves. Additionally, disposing the coil portion 130, the driver IC 140, and the external connection pad 111 and coil connection pad 113 on one surface of the printed circuit board 110, reduces manufacturing costs.

The driver IC 140 includes a location sensor to detect a location of the magnet 120. That is, the location sensor detects a location of the magnet 120, and the driver IC 140 uses the detected location of the magnet 120 to control a current applied to the coil portion 130. Here, the location sensor may be a hall sensor. The hall sensor may detect changes in magnetic force. Accordingly, the location of the magnet 120 may be more precisely detected. As such, the actuator 100 detects a location of the magnet 120 so as to precisely control displacement of the magnet 120 or the printed circuit board 110.

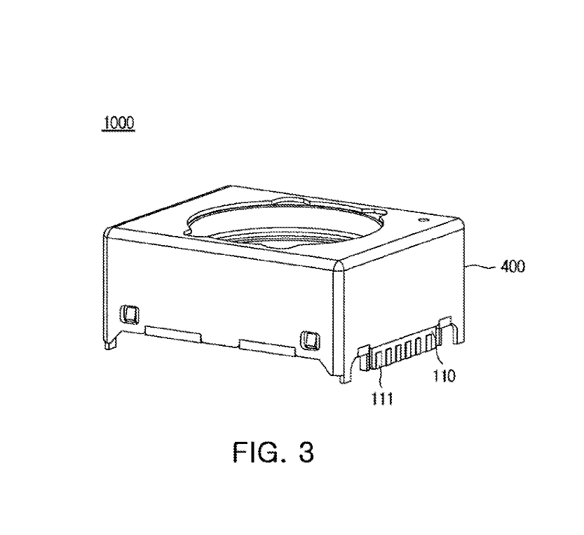

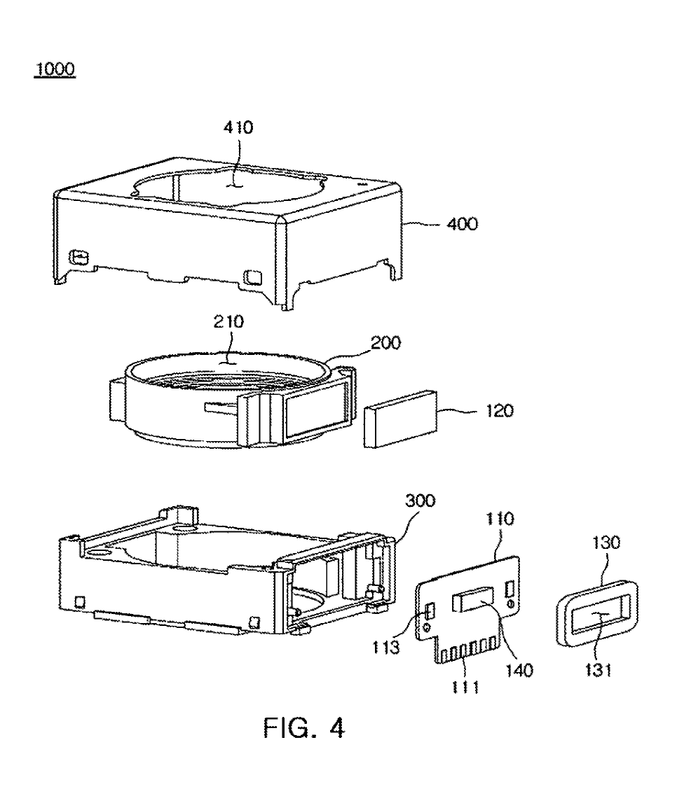

As illustrated in FIGS. 3 and 4, the camera module 1000 includes a lens barrel 200, a housing 300, and the actuator 100, and further includes a shield can 400. The lens barrel 200 accommodates a lens. That is, the lens barrel 200 includes a cylindrical accommodation hole 210 accommodating a lens disposed along an optical-axis direction. The lens barrel 200 may accommodate a plurality of lenses in the accommodation hole 210 so as to focus an object image on an image sensor (not shown). The lens barrel 200 may include a spacer (not shown) so as to maintain a predetermined interval between a plurality of lenses disposed in the lens barrel 200.

The housing 300 accommodates the lens barrel 200 therein. That is, the housing 300 covers an outer circumferential surface of the lens barrel 200 in order to protect the lens barrel 200 from external impacts. The housing 300 accommodates the lens barrel 200 so as to allow the lens barrel 200 to be movable along an optical axis by the actuator 100. The housing 300 further includes a guide ball, or ball bearing, guiding movement of the lens barrel 200 along an optical-axis direction.

Here, the printed circuit board 110 is coupled to the housing 300, and the magnet 120 is coupled to an outer circumferential surface of the lens barrel 200 so as to face the other surface of the printed circuit board 110. Since the printed circuit board 110 is fixed to the housing 300, restricting displacement of the coil portion 130, and the magnet 120 is movable with the lens barrel 200 within the housing 300 along the optical axis, the lens barrel 200 is movable along an optical axis according to a Lorentz force generated between the coil portion 130 and the magnet 120.

As illustrated in FIG. 3, the external connection pad 111 is exposed externally from the shield can 400 when the shield can 400 is coupled to the housing 300. In this case, the external connection pad 111 may be easily coupled to an external power source and other external components. The shield can 400 covers the housing 300 to shield electromagnetic waves radiated from the actuator 1000. That is, the shield can 400 is coupled to and surrounds an external portion of the housing 300 in which the lens barrel 200 and the actuator 100 are disposed. In addition, the shield can 400 protects the camera module 1000 from external impacts.

The shield can 400 may be formed of a dielectric material so as to shield electromagnetic waves. In addition, an opening 410 exposing the lens barrel 200 outward is formed in an upper surface of the shield can 400.

As such, in the camera module 1000 the coil portion 130, the driver IC 140, and the external connection pad 111 and the coil connection pad 113 are installed on one surface of the printed circuit board 110 instead of the other surface facing the lens barrel 200, thereby preventing damage to the coil portion 130 or the driver IC 140, which may occur as the lens barrel 200 moves on an optical axis. In addition, since the coil portion 130 and the driver IC 140 may be exposed externally from the housing 300, when the coil portion 130 or the driver IC 140 is damaged, the coil portion 130 or the driver IC 140 may be easily repaired.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An actuator comprising:
a printed circuit board comprising an external connection pad formed on one surface of the printed circuit board;
a magnet disposed to face another surface of the printed circuit board;
a coil portion disposed on the one surface of the printed circuit board; and
a driver integrated circuit (IC), disposed on the one surface of the printed circuit board, configured to control a current applied to the coil portion.

2. The actuator of claim 1, wherein the printed circuit board further comprises a coil connection pad, disposed on the one surface, configured to electrically connect to the coil portion.

3. The actuator of claim 1, wherein the driver IC comprises a location sensor detecting a location of the magnet.

4. The actuator of claim 3, wherein the location sensor is a hall sensor.

5. A camera module comprising:
a lens barrel;
a lens disposed in the lens barrel;
a housing, wherein the lens barrel is disposed in the housing; and
an actuator configured to move the lens barrel along an optical axis of the lens,
wherein the actuator comprises:
a printed circuit board, coupled to the housing, comprising an external connection pad formed on one surface of the printed circuit board,
a magnet coupled to an outer circumferential surface of the lens barrel to face another surface of the printed circuit board,
a coil portion installed on the one surface of the printed circuit board, and
a driver integrated circuit (IC), disposed on the one surface of the printed circuit board, configured to control a current applied to the coil portion.

6. The camera module of claim 5, wherein the printed circuit board further comprises a coil connection pad, disposed on the one surface, is electrically connected to the coil portion.

7. The camera module of claim 5, wherein the driver IC comprises a location sensor, wherein the location sensor detect a location of the magnet.

8. The camera module of claim 7, wherein the location sensor is a hall sensor.

9. The camera module of claim 5, further comprising a shield can covering the housing, wherein the shield can shields electromagnetic waves.
